(19) United States
(12) Patent Application Publication
(10) Pub. No.: US 2006/0213754 A1
(43) Pub. Date: Sep. 28, 2006

(54) Method and system for computer application program task switching via a single hardware button

(75) Inventors: Robert J. Jarrett, Snohomish, WA (US); Leroy B. Keely, Portola Valley, CA (US); Emily K. Rimas-Ribikauskas, Seattle, WA (US)

Correspondence Address: LAW OFFICES OF ALBERT S. MICHALIK;C/O MICROSOFT CORPORATION, 704 - 228TH AVENUE NE, SUITE 193, SAMMAMISH, WA, 98074, US

(73) Assignee: Microsoft Corporation, Redmond, WA (US)

(21) Appl. No.: 11/083,777

(22) Filed: Mar. 17, 2005

(51) Int. Cl. H01H 9/28; H01H 9/26

(52) U.S. Cl. 200/43.01; 200/50.37

(57) ABSTRACT

Described is a computer-implemented system and method that detects and differentiates different actuation methods entered via a single hardware button, and then takes different task (application program window) switching actions based on the type of actuation method detected. Example button actuation methods include double actuation, press-and-hold, single actuation, and also latent double actuation (which is slower than double actuation, but fast enough to be differentiated from a single actuation). Example task switching actions include toggling focus between two programs, cycling focus between each active program, presenting a Start menu, and/or presenting a list of active programs to select. The single hardware button may be dedicated to task switching, or may be a multi-purpose button that performs task switching when entered into a task switching mode via one actuation method, and performs one or more other functions when not in the task switching mode.

### FIELD OF THE INVENTION

The present invention relates generally to computing devices, and more particularly to user interaction with computing devices.

### BACKGROUND OF THE INVENTION

Contemporary computing devices allow users to input information in a number of ways, including via a keyboard, by or more types of pointing devices, and dedicated hardware buttons (typically on portable devices). With respect to buttons, some personal computers, such as tablet-based personal computers, have one or more buttons that allow the user to perform some tasks without taking out the pen or use a finger to interact with the digitizer built into the display screen. Buttons are particularly valuable when reading, because there is little interaction needed, and often no reason for the user to take out the pen. A typical use of these buttons is to scroll through a document, where two buttons would be employed to perform page up and page down operations, respectively, or read email, where buttons would allow navigation operations for an email program.

One desirable operation for a hardware button is to change the current application, otherwise known as task switching. However, typical tablet-based personal computers only provide for a single hardware button to jump between applications. This leads to an end-user experience that is less than desirable, and somewhat confusing, because most users typically want other behavior for task switching.

### SUMMARY OF THE INVENTION

Briefly, the present invention provides a system and method that detects and differentiates different actuation methods entered via a single hardware button, and then takes different task switching actions based on the type of actuation method detected. For example, in one implementation, the button is actuated in different ways that map to different actions, such as double actuation (which is relatively fast, like double clicking a mouse), press-and-hold, single actuation, and latent double actuation (which is slower than double actuation, but fast enough to be differentiated from a single actuation).

The different task switching actions that can be performed may include toggling focus between the last two most-recently-accessed application programs, cycling to focus (in turn) each active program (and possible a Start menu), presenting a Start menu from which to launch programs, and/or presenting a list of active programs from which to select, e.g., by using navigation and Enter buttons. Other actions are feasible. In one implementation, the user may map actions to actuation methods.

The single hardware button may be dedicated to task switching, or may be a multi-purpose button that performs task switching when entered into a task switching mode via one actuation method, and performs one or more other functions when not in the task switching mode. The button actuation methods may thus be used to enter and exit a task switching mode, as needed, and the mode may be automatically exited as part of an action. Visible indications of the task-switching mode may be shown when active, as well as visible indications related to the timing used in button method differentiation.

Other advantages will become apparent from the following detailed description when taken in conjunction with the drawings, in which:

### BRIEF DESCRIPTION OF THE DRAWINGS

FIG. 1 is a block diagram representing an exemplary computer system into which the present invention may be incorporated;

FIG. 2 is a block diagram generally representing components for handling user input, including button input, in accordance with various aspects of the present invention;

FIG. 3 is a flow diagram generally representing example steps to enter into a task switching mode via a single hardware button, in accordance with various aspects of the present invention; and

FIG. 4 is a flow diagram generally representing example steps to perform a plurality of different functions via a single hardware button, in accordance with various aspects of the present invention.

### DETAILED DESCRIPTION

Exemplary Operating Environment

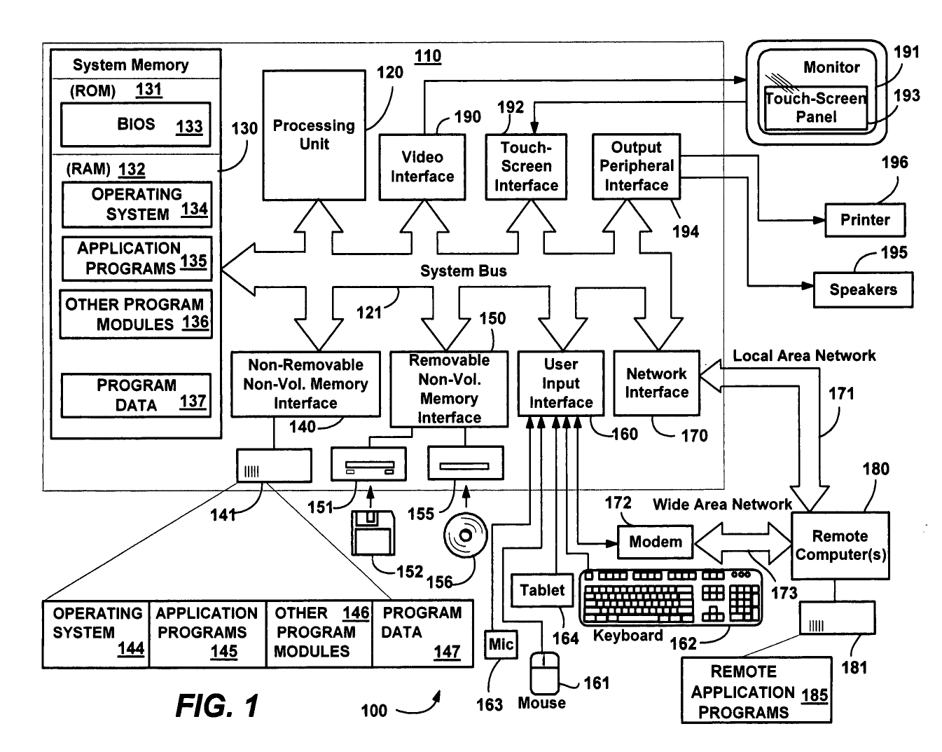

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a tablet (electronic digitizer) 164, a microphone 163, a keyboard 162 and pointing device 161, commonly referred to as mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel 193 or the like that can input digitized input such as handwriting into the computer system 110 via an interface, such as a touch-screen interface 192. Note that the monitor and/or touch screen panel can be physically coupled to a housing in which the computing device 110 is incorporated, such as in a tablet-type personal computer, wherein the touch screen panel 193 essentially serves as the tablet 164. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Program Task Switching Via a Single Hardware Button

The present invention is primarily directed to user input data entered via a hardware button, which results in various types of task switching actions. As will be understood, numerous ways to implement the present invention are feasible, and only some of the alternatives are described herein. For example, in one implementation, the button is actuated in different ways that map to different actions, such as double actuation (like double clicking a mouse), press-and-hold, single actuation, and latent double actuation (slower than double actuation, but fast enough to be differentiated from a single actuation). However, other ways to actuate buttons are feasible, including triple actuations, and patterns such as a single actuation followed by a press-and-hold action. Moreover, the different task switching actions that can be performed, such as toggling between the last two most-recently-accessed application programs in response to one type of button actuation, are only examples; an implementation in which the user configures the number of applications to switch among is straightforward to implement. As such, the present invention is not limited to any particular examples used herein, but rather may be used various ways that provide benefits and advantages in computing in general.

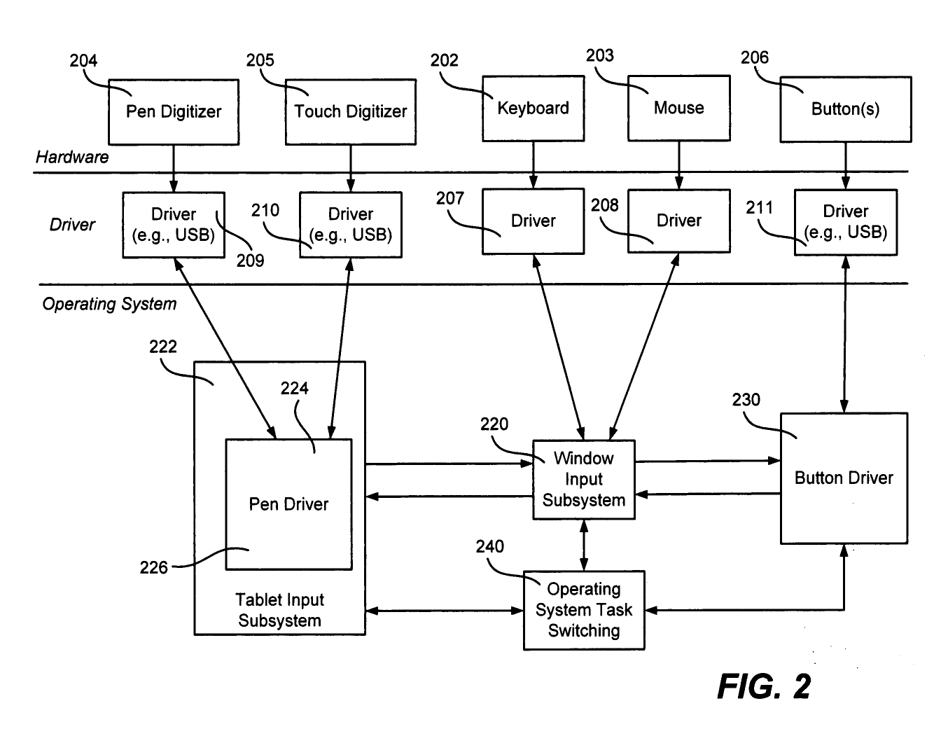

Turning to FIG. 2, there is shown an example architecture in which various hardware input (human interface) devices are shown that provide user input data, such as a keyboard 202, a mouse 203, a pen digitizer 204, a touch digitizer 205 and one or more buttons 206. Each of these devices 202-206 connects through a suitable driver (e.g., 207-211) to an operating system level component. Note that for purposes of example, each input device is shown as having its own driver, however one driver may handle the input of more than one device. In FIG. 2, the keyboard and mouse generated data are shown as being received at one operating system-level subsystem, referred to as a window input subsystem 220, while pen and touch generated data are shown as being received at another operating system-level subsystem, referred to as a tablet input subsystem 222, in a pen driver component 224 therein. The button input is received at a button driver 230. As represented in FIG. 2, the button driver 230 can, if desired, accomplish task switching by sending simulated keystrokes to the window input subsystem 220, and/or by communicating with the operating system's task switching component 240. However, other architectures and components are feasible.

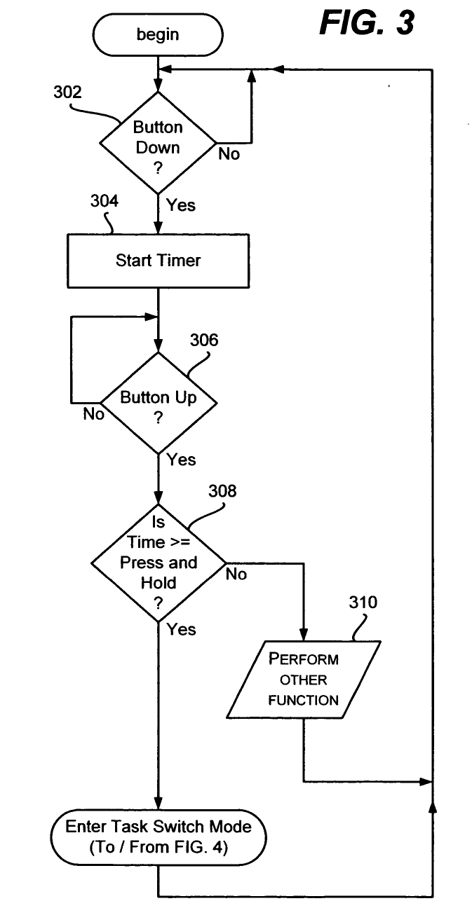

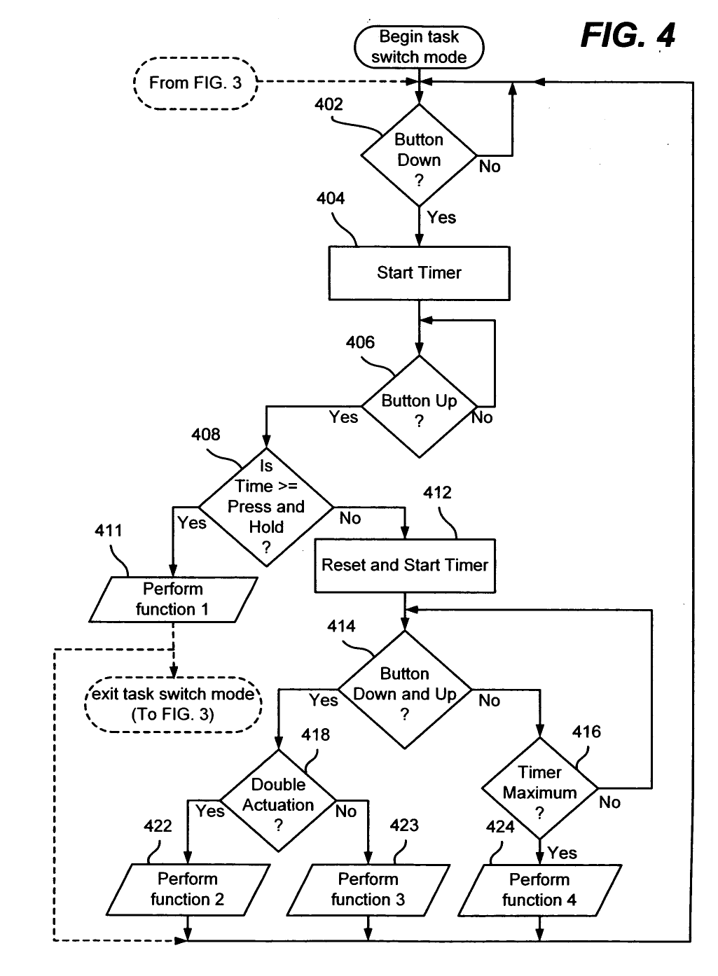

Essentially, the button driver 230 knows the state of each button, that is, when any button is up or down. As described below with reference to FIGS. 3 and 4, the button includes logic that handles button actuations related to task switching. In particular, a single task-switching button, which may also have other functionality, is evaluated for various types of actuation methods performed by the user. Task switching operation is then controlled in various ways based on the different actuation methods that are recognized.

The task switching button may be dedicated to task switching, or may be a multi-purpose button used to perform one or more other actions as well. For example, when actuated in one way, a hardware button may toggle the display orientation of a tablet-based personal computer between landscape and portrait orientations. When actuated in another way, the same button may enter a mode in which the button is used for task switching, until deactivated.

By way of example, FIG. 3 shows how a single button can be used for task switching and at least one other purpose. In the example of FIG. 3, a press-and-hold operation enters the task switching mode.

Step 302 of FIG. 3 represents waiting for a button down event. Note that while step 302 is shown as looping forever until a button down is detected, other mechanisms such as one that starts up the driver logic on a button down event are feasible. When detected, step 302 branches to step 304 which starts a timer.

At step 306, the process waits for a button up event. When received, step 308 is executed, which evaluates the time that the button was held down against a press-and-hold time. Note that the press-and-hold time may be user configurable, or set by default to some reasonable time (e.g., on the order of one or two seconds) that clearly differentiates a user's press and hold intention versus another type of actuation. Further note that some visible indication may be given, possibly after some delay, to inform the user of the time remaining before the threshold press-and-hold time will be achieved.

If the press-and-hold time was not reached, step 308 branches to step 310 to perform the button's other function; note that such a function can actually further distinguish between other button actuation methods (other than press-and-hold) to make a decision on some further action, e.g., take one action on a double-actuation, and another action on a single actuation.

If the press-and-hold time was reached, step 308 enters the task switching mode, generally represented in FIG. 4. Note that by putting step 308 in the “button up” loop represented by step 306, it is possible to enter this mode when the user holds the button for the threshold time, even without releasing it; in such an event a button up before the time will branch to step 310, while reaching the time will enter the task switching mode, with the button still pressed.

It should be noted that the task switching mode of FIG. 4 can be used with a hardware button dedicated to task switching, and in such a situation is essentially always active while the device is operating. Thus, in FIG. 4, the entry point to FIG. 4 from FIG. 3 is shown via dashed lines, to indicate that a non-dedicated button as described in FIG. 3 is one optional way to enter the mode. Notwithstanding, even with a dedicated button, the mode can be turned on or off via the dedicated button, e.g., instead of performing another function at step 310, there may be an immediate window switch, in which the previous window is activated and the mode is ended.

Step 402 represents waiting for a button down while in the task switching mode of operation; this is again represented as a loop, but may be an event-awakened process. Step 404 starts a timer on the button down event, and step 406 waits for a button up when the user releases the button.

Step 408 represents evaluating whether the time held was a press-and-hold action for a sufficient amount of time. The threshold press-and-hold time evaluated at step 408 need not be the same amount of time as the press-and-hold time of FIG. 3. If so, step 408 branches to step 411 to perform some action, shown as action 1.

In the situation where a non-dedicated button was used to enter the task switching mode, one such action would be to exit the task switching mode, as represented by the dashed lines below step 411. This would allow a user to press and hold to enter the task switching mode, use it as desired, and then press and hold to exit the task switching mode. The exit actuation method need not be the same as the enter actuation method, however, e.g., press and hold to enter, double actuate to exit.

Alternatively, such as with a dedicated task switching hardware button, some other action (described below) may be performed for a press and hold in the task switching mode. After the action, as indicated by the optional other dashed line, the process returns to step 402 to await further user actuation of the button. Note that the action may leverage other buttons that are available, e.g., up and down arrows, and the enter key. For example, one task-switching related action may provide a start menu, or present a group of programs from which to select one. Movement arrows and an Enter key button may be used to navigate and make the selection.

Returning to step 408, in the event that the press and hold time was not reached, step 408 branches to step 412 to start another timer, (which may be the same one as used in step 404). This time, the timer will be used to differentiate between other actuation methods, and continues until the user again presses and releases the button (step 414), or the timer reaches some maximum amount of time (step 416).

If there is a button up and down, step 414 branches to step 418, which evaluates the time to determine whether the user double-actuated the button relatively quickly (like a mouse double-click). If so, step 418 branches to step 422 to perform whatever task-switching action is mapped to a double-actuation, as described below. Otherwise, this is a slow double actuation, referred to as a latent double actuation, which branches to step 423 to perform a (typically) different task-switching action.

Returning to steps 414 and 416, if the user has not pressed the button a second time at step 414, the maximum time will be reached. This is essentially a single actuation, whereby step 424 is executed to perform a (typically) different task-switching action. Note that some visible indication may be given to the user to indicate when this time is to be reached, so that, for example, a user is not frustrated waiting for the single press (detected at steps 402 and 406) to result in an action. Indeed, if latent double actuation is not active, the maximum time at step 416 can be the double-actuation time, which is very short, and step 416 can go directly to step 422.

As can be seen from FIG. 4, a single button can be used to perform up to four different task switching-related actions, depending on how the user presses the button. As described below, the user may configure which button pressing methods perform which actions, and even deactivate certain ones. Significantly, when in the task switching mode, whether always active for a dedicated button or entered via a multi-purpose button (FIG. 3), the mode persists after the button has been released.

A number of task switching actions are possible, including back-and-forth “toggling” between two applications, including changing back and forth between which program's window has focus, and predictable “cycling” through all running application programs, including bringing each program window to a foreground state for each program when it is that program's turn in the cycle, that is, interactively switching to the application. The user may also be presented with a list of active programs to explicitly choose the application program to switch to from a list. The user may also be presented with Start menu, including possibly inactive programs, from which an application program instance may be launched, (or switched to if already active and not more than one instance may be run at a time). The present invention provides such actions by mapping the button actuation method to a task switching action.

Another desirable action provides the user with access to the operating system's Start menu user interface, to allow new applications to be started. This may be done by mapping an action to the Start menu, and/or by treating the Start menu as one of the running application programs while in the task switching mode. Note that the Start menu may thus appear as one selectable option with which to interface when cycling through application programs.

As can be seen from FIG. 4, different outcomes can be determined from a single button, by differentiating actuation methods including quickly pressing and releasing the hardware button, pressing and holding in the hardware button for some specified amount of time, optionally releasing the button, quickly pressing and releasing the hardware button twice in rapid succession (“double actuation”) and quickly pressing and releasing the hardware button twice, in slower, but not too slow succession (“latent double actuation”).

The user may map these methods to actions, or a default mapping may be provided. By way of example, one configuration may map a single button tap to toggling between two current applications, a double actuation to invoke the start menu, and a latent double actuation to cycles between all current application programs. Another configuration may map a single button tap to toggle between two application programs, and a press and hold to cycle between all current application programs. Note that although the example of FIG. 4 requires a button up for a press and hold, step 408 could be moved into the loop of step 406 whereby the press and hold time could be reached while the button was held down and not released. Yet another example maps a single button tap to cycle between current applications modally, a press and hold to invoke the start menu, and a double click to toggle between two current applications, e.g., the two that most recently had focus.

A user need not map an action to an actuation method. Thus, as described above, a user can elect to not use the latent double actuation method, and instead have a quick tap, a double actuation, and a press and hold action. Further, the methods described herein are only some examples; a user can use other methods such as a triple actuation. Similarly, the actions described herein are only some examples of task switching, and indeed, a user could do some other action, such as launch a particular program, from within the task switching mode.

In sum, when task switching is invoking via a single button, a mode is entered in which actions may occur. However, it should be understood that FIG. 4 is only one way to implement the present invention. For example, the mode may end upon a user activating a particular program, e.g., once in the mode, pressing an arrow key will navigate among different program windows for activation; pressing Enter will accept the current choice, activate the selected program, (focus its window) and end the mode. The mode may also end via a time out if nothing is done with the button after using it to enter the mode. Note that even in implementations where a dedicated button is present and the mode is always active, any visible indications of the mode may be cleaned up, such as after a time out expiration or a user selection.

As can be seen from the foregoing detailed description, there is provided a method and system that uses a single button to control task switching in a variety of ways. The button may be dedicated to task switching, or may be shared with different functionality. Distinctions are detected with the same button via different actuation methods.

While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention.

What is claimed is:

1. In a computing device, a computer-implemented process, comprising:
detecting a button actuation method entered via a single hardware button;
differentiating the button actuation method from at least one other button actuation method; and
taking a task switching-related action corresponding to the button actuation method.

2. The process of claim 1 wherein differentiating the button actuation method comprises recognizing a double actuation.

3. The process of claim 1 wherein differentiating the button actuation method comprises recognizing a latent double actuation.

4. The process of claim 1 wherein differentiating the button actuation method comprises recognizing a single actuation.

5. The process of claim 1 wherein differentiating the button actuation method comprises recognizing a press-and-hold actuation.

6. The process of claim 1 wherein taking the task switching-related action comprises cycling between a plurality of programs, including bringing a program window to a foreground state for each program when it is that program's turn.

7. The process of claim 6 wherein one program corresponds to a start menu having a plurality of program representations displayed thereon, including a representation for at least one inactive program, and from which one program may be selected for launching.

8. The process of claim 1 wherein taking the task switching-related action comprises toggling between two programs, including alternating which program window of the two programs has focus.

9. The process of claim 1 wherein taking the task switching-related action comprises presenting a selection list having program representations for a plurality of active programs displayed thereon and from which one program may be selected to receive focus.

10. The process of claim 1 wherein taking the task switching-related action comprises presenting a start menu having a plurality of program representations displayed thereon, including a representation for at least one inactive program, and from which one program may be selected for launching.

11. The process of claim 1 further comprising, entering a mode in which detecting the button actuation method is active.

12. A computer-readable medium having computer-executable instructions, which when executed perform the process of claim 1.

13. A computer-readable medium having computer-executable instructions, which when executed perform steps, comprising:
detecting a first button actuation method entered via a single hardware button;
taking a first task switching-related action corresponding to the first button actuation method;
detecting a second button actuation method entered via the single hardware button, in which the second button actuation method is different from the first button actuation method; and
taking a second task switching-related action corresponding to the second button actuation method, in which the second task switching-related action is different from the first task switching-related action.

14. The computer-readable medium of claim 13 wherein detecting the first button actuation method comprises differentiating between at least two actuation methods of a set of possible actuation methods, the set including a double actuation, a latent double actuation, a single actuation and a press-and-hold actuation.

15. The computer-readable medium of claim 13 wherein taking the first task switching-related action comprises performing at least one action from a set of possible actions, the set including, cycling to focus one program window at a time for each of a plurality of programs, providing a start menu having a plurality of program representations displayed thereon from which a program may be selected for launching, toggling to alternate which program window of a subset of active at least two active programs has focus, and presenting a selection list having program representations for a plurality of active programs displayed thereon and from which one program may be selected to receive focus.

16. The computer-readable medium of claim 13 having further computer-executable instructions, comprising, entering a mode in which detecting the first and second button actuation methods is active.

17. In a computing device having a program, a system comprising:
a single hardware button; and
a button driver coupled to the single hardware button, the button driver including a mechanism that differentiates between at least two types of detected button actuation methods, and takes a task switching-related action for each button actuation method detected.

18. The system of claim 17 wherein the single hardware button is dedicated to task switching actions.

19. The system of claim 17 wherein the single hardware button provides task switching actions and at least one other function not related to task switching actions, and wherein the button driver enters a task switching mode upon detecting a particular button actuation method.

20. The system of claim 17 wherein the detected button actuation methods include at least two actuation methods of a set of possible actuation methods, the set including a double actuation, a latent double actuation, a single actuation and a press-and-hold actuation, and wherein taking the task switching-related action comprises performing at least one action from a set of possible actions, the set including, cycling to focus one program window at a time for each of a plurality of programs, providing a start menu having a plurality of program representations displayed thereon from which a program may be selected for launching, toggling to alternate which program window of a subset of active at least two active programs has focus, and presenting a selection list having program representations for a plurality of active programs displayed thereon and from which one program may be selected to receive focus.
